(19) United States
(12) Patent Application Publication
(10) Pub. No.: US 2011/0010643 A1
(43) Pub. Date: Jan. 13, 2011

(54) DEVICE AND METHOD FOR PERFORMING REOMOTE INTERNET BROWSING BETWEEN PORTABLE DEVICES

(75) Inventors: Gene-Moo Lee, Seongnam-si (KR); Jin-Wook Lee, Yongin-si (KR); Je-Hyok Ryu, Suwon-si (KR); Hun Lim, Seongnam-si (KR); Woo-Jin Park, Yongin-si (KR); Jin-Hyoung Kim, Hwaseong-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/831,377

(22) Filed: Jul. 7, 2010

(30) Foreign Application Priority Data
Jul. 7, 2009 (KR) 10-2009-0061818
May 14, 2010 (KR) 10-2010-0045314

(51) Int. Cl. G06F 15/173; G06F 3/01

(52) U.S. Cl. 715/760; 709/223

(57) ABSTRACT

A method and apparatus for performing Internet browsing, in which a remote communication-enabled device accesses Internet, and connects a web browsing device to the Internet through local communication. The remote communication-enabled device additionally transmits control commands and input information for controlling a web browser to the web browsing device, which in turn runs a web browser using the received control information.

### PRIORITY

This application claims priority under 35 U.S.C. §119(a) to an application filed in the Korean Intellectual Property Office on Jul. 7, 2009 and assigned Serial No. 10-2009-0061818, and an application filed in the Korean Intellectual Property Office on May 14, 2010 and assigned Serial No. 10-2010-0045314, the entire disclosures of both applications are hereby incorporated by reference.

### BACKGROUND OF THE INVENTION

1. Field of the Invention

The present invention relates to a device and method for facilitating remote web browsing between portable devices.

2. Description of the Related Art

Various services are available to facilitate the connection of local communication devices, such as a cellular phone or personal digital assistant. Such services may constitute a Wireless Personal Area Network (WPAN), which can connect local communication devices to each other quickly and easily. A WPAN provides control and messaging between devices that may have complex communication demands.

With the advent of technologies like WPAN, a variety of services are now available between local communication devices.

FIG. 1 illustrates conventional remote browsing between local communication devices. The local communication devices shown in FIG. 1 may be connected by any of a variety of network protocols such as Wi-Fi, ZigBee, Bluetooth, Ultra Wide Band Communication, etc.

Referring to FIG. 1, a first local communication device 101 is connected to the Internet via a mobile communication network. The first local communication device 101 may also access a second local communication device 103 and allow the secondary device to browse the web remotely. If the first and second local communication devices 101 and 103 display at different resolutions, the first local communication device 101 may convert its resolution to the appropriate resolution of the second local communication device 103. Otherwise, the second local communication device 103 may convert the incoming resolution to a more suitable value.

Mobile terminals have famously small displays but connect to an Internet that is largely resolution-independent. While traditional remote connection solutions rely on scaling an image of the program (say a web browser), this usually comes at the expense of pixel density or viewability. To address these deficiencies, there is a need for a way to render web traffic at native resolutions for each local communication device.

### SUMMARY OF THE INVENTION

An aspect of the present invention addresses the aforementioned problems and/or disadvantages and provides the advantages described below. Accordingly, an aspect of the present invention provides a web browsing device, which includes a web browser equipped to connect to the Internet via a corresponding device that is connected to a web browsing device through a local communication protocol. The web browsing device also includes a display manager for rendering the browsing session and a control server for analyzing control commands and directing the web browser.

Another aspect of the present invention provides a remote communication-enabled device, including a user interface for receiving commands and displaying control information and a control client for managing connections to the Internet, connections from the Internet to a corresponding web browsing device, and transmitting data to a corresponding web browsing device.

In accordance with another aspect of the present invention, there is provided a method for performing web browsing, which includes accessing the Internet with a remote communication-enabled device, and connecting the Internet to a web browsing device though local communication. The method also includes provisions for transmitting data for controlling a web browser to the web browsing device and running a web browser using the data on the web browsing device.

### BRIEF DESCRIPTION OF THE DRAWINGS

The above and other aspects, features and advantages of certain embodiments of the present invention will be more apparent from the following description when taken in conjunction with the accompanying drawings, where:

FIG. 1 illustrates conventional remote web browsing between local communication devices;

FIG. 2 illustrates a local communication device performing remote communication according to an embodiment of the present invention;

FIG. 3 illustrates a local communication device, which runs a web browser according to an embodiment of the present invention;

FIG. 4 illustrates initiating a browsing session according to an embodiment of the present invention;

FIG. 5 illustrates terminating a browsing session according to an embodiment of the present invention;

FIG. 6 illustrates synchronizing a browser bookmark according to an embodiment of the present invention;

FIG. 7 illustrates a process of updating a bookmark according to an embodiment of the present invention;

FIG. 8 illustrates a process of entering key input data according to an embodiment of the present invention;

FIG. 9 illustrates mouse input according to an embodiment of the present invention;

FIG. 10 illustrates a process of remotely controlling a browser according to an embodiment of the present invention;

FIG. 11 illustrates a remotely controlled web requests according to an embodiment of the present invention; and

FIG. 12 illustrates a remotely controlled browsing session according to an embodiment of the present invention.

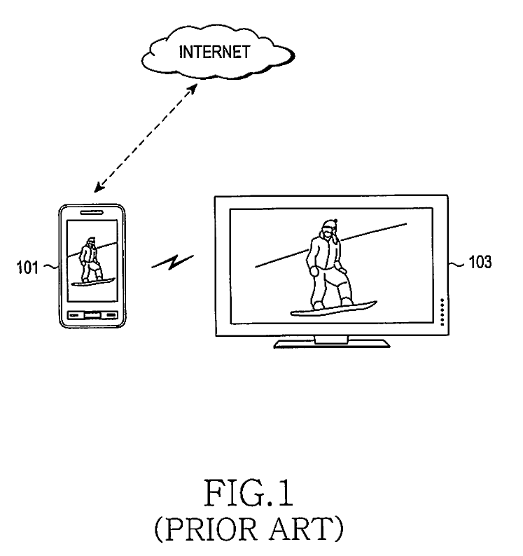

Throughout the drawings, the same drawing reference numerals will be understood to refer to the same elements, features and structures.

### DETAILED DESCRIPTION OF EMBODIMENTS OF THE PRESENT INVENTION

Various embodiments of the present invention are described with reference to the accompanying drawings. In the following description, specific details such as detailed configuration and components are merely provided to assist the overall understanding of certain embodiments of the present invention. Therefore, it should be apparent to those skilled in the art that various changes and modifications of the embodiments described herein can be made without departing from the scope and spirit of the invention.

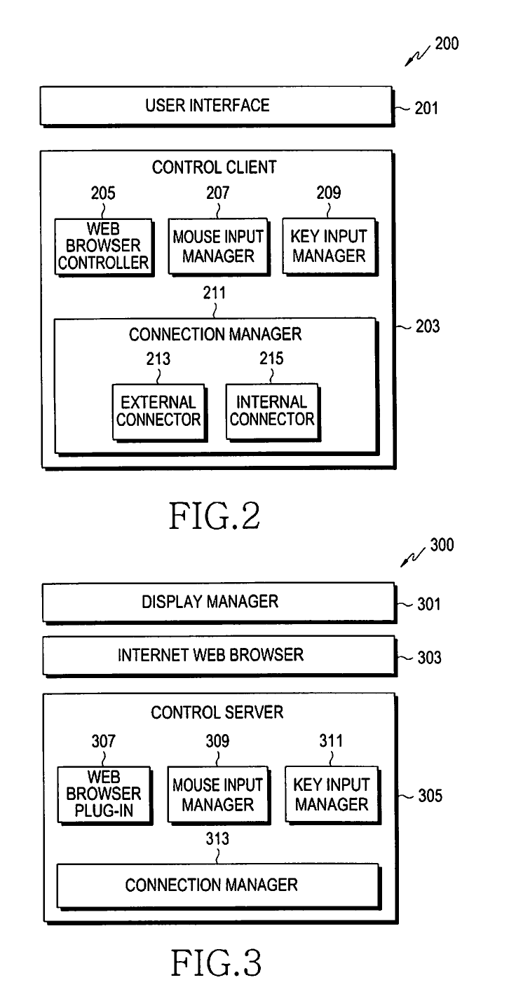

FIG. 2 illustrates a local communication device performing remote communication according to an embodiment of the present invention. The remote communication method may include Ethernet, xDSL, etc., or mobile communication networks such as Code Division Multiple Access (CDMA), Global System for Mobile communication (GSM) and Wideband CDMA (WCDMA) A local communication device 200 in FIG. 2 consists of a user interface 201 and a control client 203, and the control client 203 consists of a web browser controller 205, a mouse input manager 207, a key input manager 209, and a connection manager 211. The connection manager 211 includes an external connector 213 and an internal connector 215.

Referring to FIG. 2, the user interface 201 receives necessary inputs when a user performs Internet browsing. The inputs may be received through an input device such as a keyboard, a mouse or a touch screen, and the received inputs may be displayed on an output device like the screen during or after the input process. For example, the keyboard may be used to input an Internet address and the mouse may be used to designate a hyperlink of a web page. Both the position of the mouse and the data from the keyboard could be displayed on device's screen.

The control client 203 receives commands from the user via the user interface 201, and in turn sends commands to a corresponding local communication device in which a browser can run—such as a web browsing device. The control client 203 consists of the web browser controller 205, the mouse input manager 207, the key input manager 209, and the connection manager 211, each of which is described below.

The web browser controller 205 analyzes a user's web browser control command received from the user interface 201 and generates a message requesting the pertinent control operation. The generated message is provided to the connection manager 211. Upon sensing inputs by a mouse or keyboard, the mouse input manager 207 or the key input manager 209 analyze these inputs, generate input messages, and provide them to the connection manager 211. The key input undergoes encryption during transmission because it is entered in the form of text and thus is susceptible to third-party interception. While the mouse input manager 207 and the key input manager 209 are shown as separate components in the drawing, they may be merged into a single component.

The connection manager 211 consists of the external connector 213 and the internal connector 215. The external connector 213 is provided to initiate, terminate or maintain a connection to the Internet, and the internal connector 215 is provided to start, end or maintain a connection to a corresponding local communication device in which an Internet browser may run.

FIG. 3 illustrates a local communication device in which an Internet browser runs, according to an embodiment of the present invention. A local communication device 300 in FIG. 3 may be connected to a remote communication-enabled local communication device using Wi-Fi, Bluetooth, ZigBee, etc. The local communication device 300 consists of a display manager 301, a web browser 303, and a control server 305. The control server 305 includes a web browser plug-in 307, a mouse input manager 309, a key input manager 311, and a connection manager 313.

Referring to FIG. 3, the display manager 301 draws a browsing session through a screen connection interface such as High Definition Multimedia Interface (HDMI), Universal Serial Bus (USB), Digital VideoNisual Interactive (DVI), etc.

The web browser 303 performs Internet browsing using a particular program. The particular program may include Microsoft Internet Explorer®, Mozilla Firefox®, Apple Safari®, etc.

The control server 305 consists of the web browser plug-in 307, the mouse input manager 309, the key input manager 311, and the connection manager 313, each of which will be described in detail below.

The web browser plug-in 307 creates a menu of operations accessible to the user for each page. Such operations are received from the remote communication-enabled local communication device 200 and may include ‘Go to Previous Page’, ‘Go to Next Page’, ‘Go to Homepage’, ‘Refresh Page’, etc. The mouse input manager 309 and the key input manager 311 interpret mouse and keyboard commands entered in the web browser 303. The connection manager 313 is provided to initiate, terminate or maintain a connection with the remote communication-enabled local communication device 200. While the mouse input manager 309 and the key input manager 311 are shown as separate components in the drawing, they may be merged into a single component.

The local communication device 300 of FIG. 3, in which an Internet browser may run, may be mounted inside an output device such as a TV or a display monitor, or may be externally connected to the output device by cable or wirelessly.

Next, processes of performing various control functions will be described in detail with reference to FIGS. 2 and 3. In the following embodiments, the remote communication-enabled local communication device 200 in FIG. 2 is hereinafter referred to as Device A and the local communication device 300 of FIG. 3, in which an Internet browser can run, is hereinafter referred to as Device B.

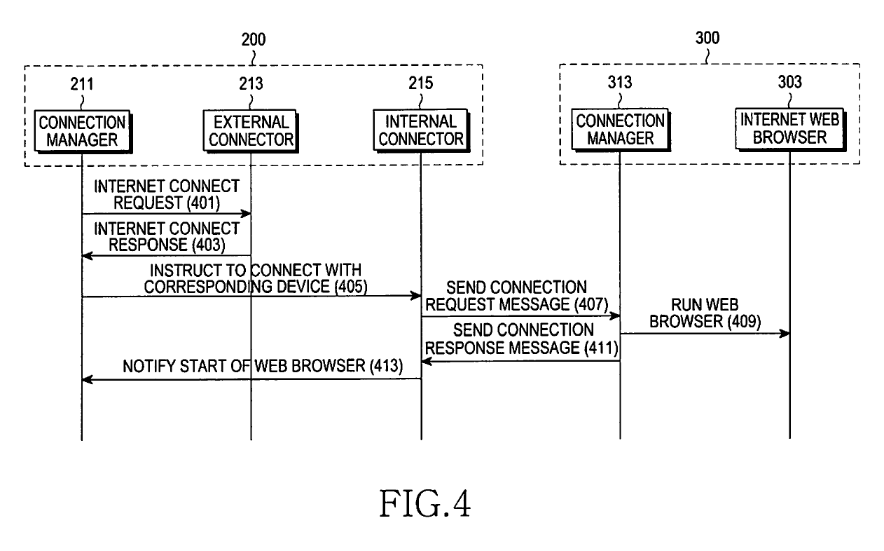

FIG. 4 illustrates a process of initiating a browsing session according to an embodiment of the present invention. When the connection manager 211 of Device A receives a request to connect to the Internet, it informs the external connector 213, demonstrated in step 401. In step 403, the external connector 213 prepares for Internet connection, and sends an Internet connect response message indicating the availability of Internet connection to the connection manager 211.

If an Internet connection is available, the connection manager instructs the internal connector 215 to connect with the corresponding secondary device, Device B, demonstrated in step 405. The internal connector 215 takes the message and contacts Device B with a “connection request message,” step 407.

Upon receiving the connection request message from the internal connector 215 in Device A, the connection manager 313 in Device B completes the connection with the Device A and runs the web browser 303, step 409. In step 411, the connection manager 313 sends a connection response message indicating the completion of the connection with Device A, to the internal connector 215 in Device A. In step 413, the internal connector 215 notifies the connection manager 211 that the web browsing session has begun.

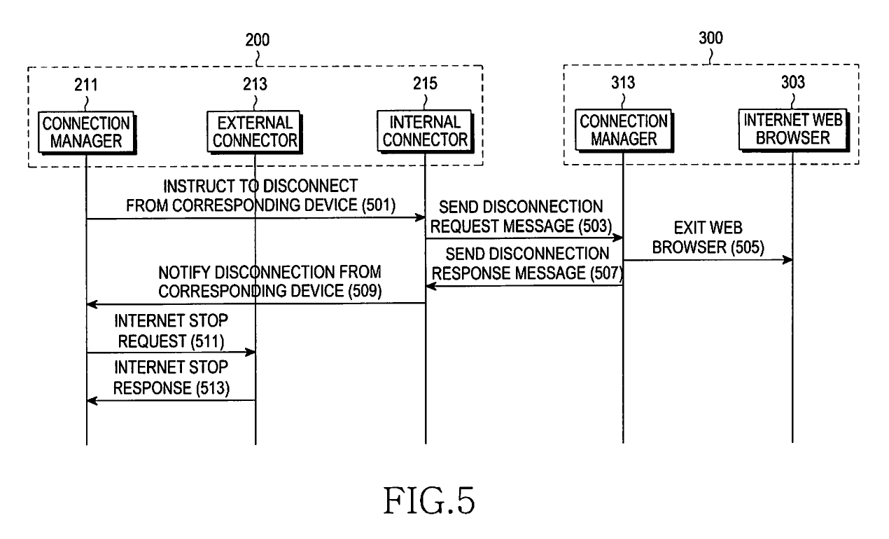

FIG. 5 illustrates a process of terminating a browsing session according to an embodiment of the present invention. Upon receiving a request to disconnect from Device B from the user, the connection manager 211 instructs the internal connector 215 to disconnect from the Device B, step 501. In step 503, the internal connector 215 sends a disconnection request message to the connection manager 313 in Device B. Upon receiving the disconnection request message from the internal connector 215 in Device A, the connection manager 313 in Device B closes the web browser 303 in step 505. In step 507, the connection manager 313 sends a disconnection response message indicating the exit of the web browser 303, to the internal connector 215 in Device A. In step 509, the internal connector 215 notifies the connection manager 211 that the browser has closed.

When the connection manager 211 has been notified that the browsing session has ended, it will send a request to terminate the Internet connection, step 511. Upon receiving the termination request, the external connector 213 will stop the Internet connection and notify the connection manager 211, step 513.

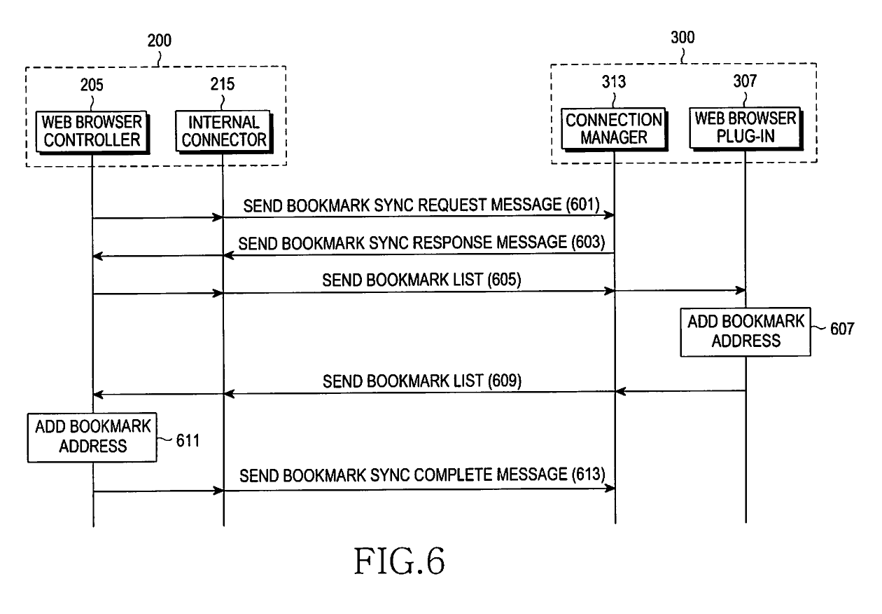

FIG. 6 illustrates a process of synchronizing a browser bookmark according to an embodiment of the present invention. The ‘bookmark function’ mentioned in FIG. 6 refers to a process of storing the address of a particular website and allowing the user to easily go to that site with a one-click input. A bookmark list may be created by collecting addresses of these particular websites.

Referring to FIG. 6, the web browser controller 205 in Device A sends a bookmark sync request message to the connection manager 313 in Device B via the internal connector 215, step 601. In step 603, upon receiving the bookmark sync request message, the connection manager 313 sends a bookmark sync response message indicating the possibility of bookmark synchronization to the internal connector 215 in Device A, and upon receiving the bookmark sync response message, the internal connector 215 forwards the message to the web browser controller 205.

In step 605, the web browser controller 205 transmits a bookmark list to the connection manager 313 via the internal connector 215. The connection manager 313 forwards the received bookmark list to the web browser plug-in 307. In step 607, the web browser plug-in 307 compares the received bookmark list with a bookmark list of Device B, and adds the bookmark addresses that are not included in Device B's bookmark list. In step 609, the web browser plug-in 307 transmits Device B's bookmark list to the internal connector 215 in Device A via the connection manager 313. The internal connector 215 forwards the received Device B's bookmark list to the web browser controller 205. In step 611, the web browser controller 205 compares the received bookmark list with the bookmark list that Device A presently has, and adds the bookmark addresses that Device A lacks. In step 613, the web browser controller 205 sends a bookmark-sync-complete message indicating the completion of the bookmark sync process, to the connection manager 313 in Device B via the internal connector 215.

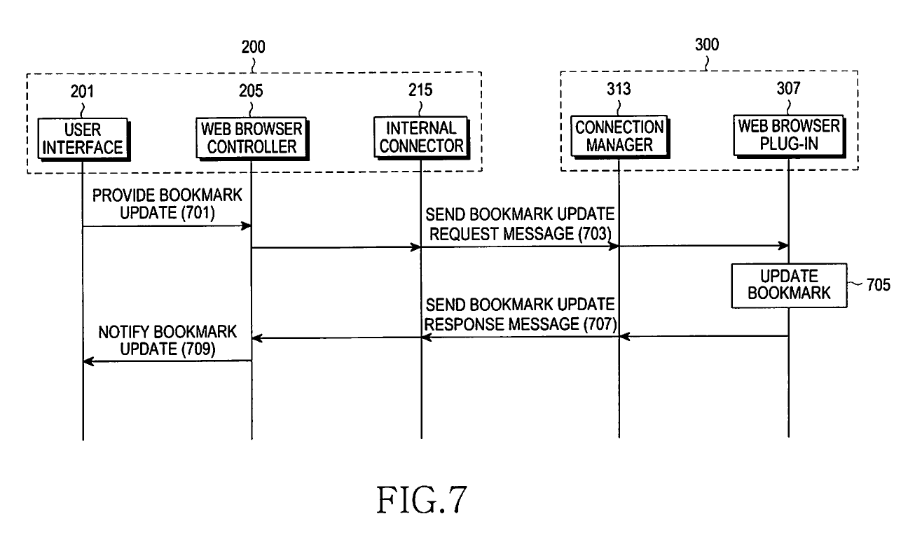

FIG. 7 illustrates a process of updating a bookmark according to an embodiment of the present invention. Upon receiving bookmark updates from the user, the user interface 201 provides bookmark update information to the web browser controller 205, step 701. The bookmark updates may include addition, deletion or modification of bookmarks. In step 703, the web browser controller 205 sends a bookmark update request message with the bookmark update information to the connection manager 313 in Device B via the internal connector 215. The connection manager 313 forwards the received bookmark update request message to the web browser plug-in 307. In step 705, the web browser plug-in 307 updates Device B's bookmark depending on the bookmark update information included in the received bookmark update request message. In step 707, upon completion of the bookmark update, the web browser plug-in 307 sends a bookmark update response message indicating the completion of the bookmark update to the internal connector 215 in Device A via the connection manager 313 The internal connector 215 forwards the received bookmark update response message to the web browser controller 205. In step 709, the web browser controller 205 outputs the bookmark update response message on an output unit of the user interface 201 in Device A to notify the user of the completion of the bookmark update.

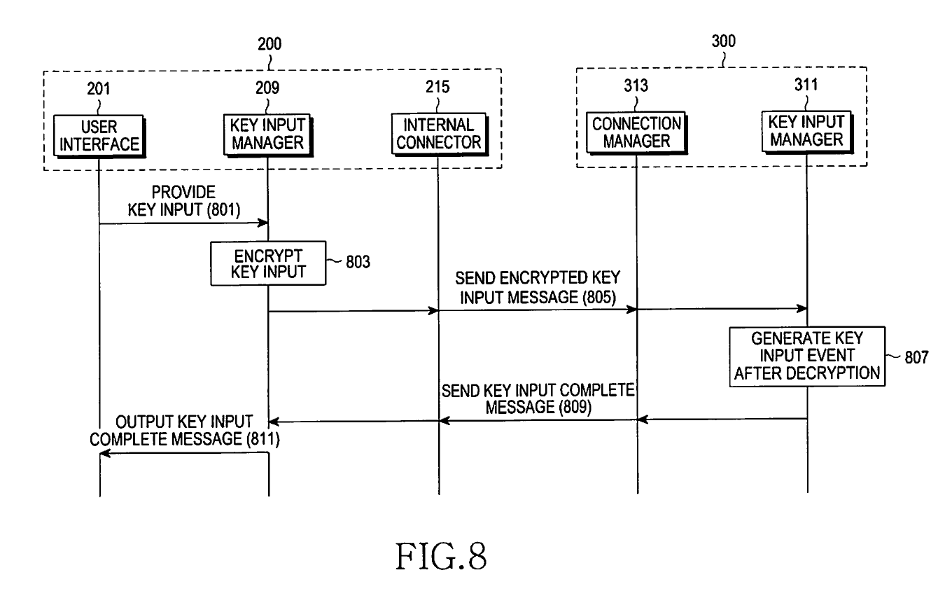

FIG. 8 illustrates key input data entry according to an embodiment of the present invention. Upon receiving a key input from the user, the user interface 201 in Device A provides key input information to the key input manager 209, step 801. The key input may be received through something like a keyboard or a touch screen, but is not limited to these devices. In step 803, the key input manager 209 encrypts the received key input information. In step 805, the key input manager 209 sends a key input message with the encrypted key input information to the connection manager 313 in Device B via the internal connector 215, and the connection manager 313 forwards the key input message to the key input manager 311. In step 807, the key input manager 311 decrypts the encrypted key input information included in the received key input message, and generates an event corresponding to the key input information. In step 809, the key input manager 311 sends a key input complete message indicating the completion of the key input to the internal connector 215 in Device A via the connection manager 313, and the internal connector 215 forwards the received key input complete message to the key input manager 209. In step 811, the key input manager 209 outputs the key input complete message on the output unit of the user interface 201 in Device A to notify the user of the completion of the key input.

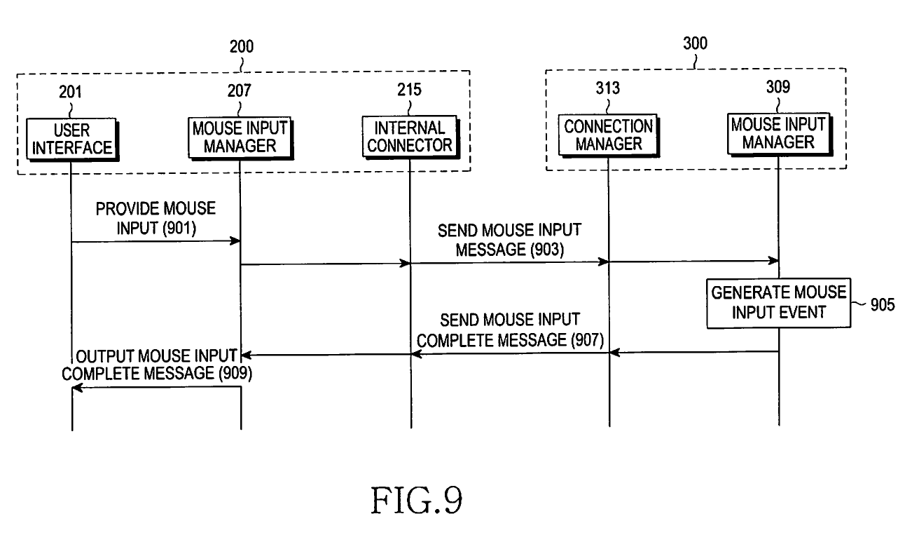

FIG. 9 illustrates mouse input according to an embodiment of the present invention. Upon receiving a mouse input from the user, the user interface 201 in Device A provides the mouse input to the mouse input manager 207, step 901. In step 903, the mouse input manager 207 sends a mouse input message with the received mouse input to the connection manager 313 in Device B via the internal connector 215, and the connection manager 313 forwards the mouse input message to the mouse input manager 309. In step 905, the mouse input manager 309 generates an event corresponding to the mouse input included in the received mouse input message. In step 907, the mouse input manager 309 sends a mouse input complete message indicating the completion of the mouse input to the internal connector 215 in Device A via the connection manager 313, and the internal connector 215 forwards the received mouse input complete message to the mouse input manager 207. In step 909, the mouse input manager 207 outputs the mouse input complete message on the output unit of the user interface 201 in Device A to notify the user of the completion of the mouse input.

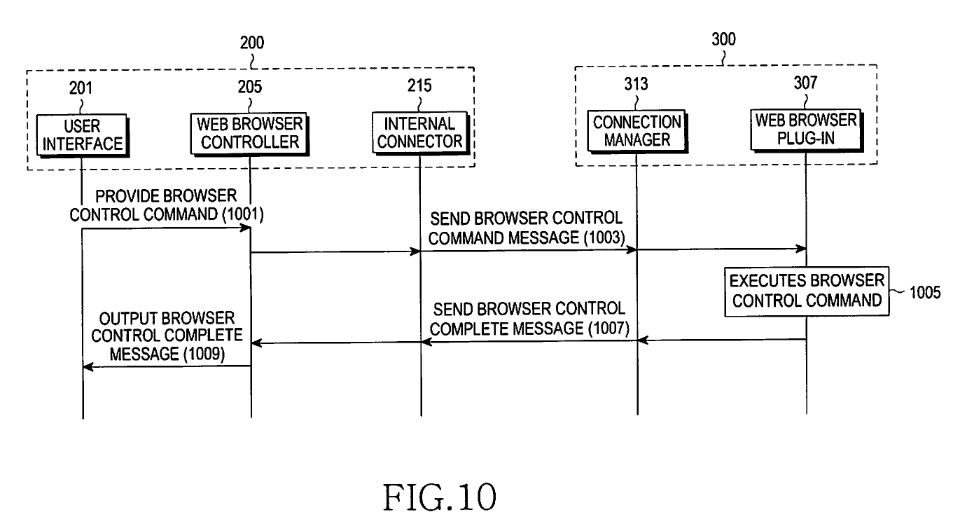

FIG. 10 illustrates remote control of a browser according to an embodiment of the present invention. When Device A receives a browser control command from the user interface 201, it is directed to Device A's web browser controller 205, step 1001. Such control commands may include ‘Go to Previous Page’, ‘Go to Next Page’, ‘Go to Homepage’, ‘Refresh Page’, etc. In step 1003, the web browser controller 205 sends a “browser control command message” to the connection manager 313 in Device B from the internal connector 215. The connection manager 313 in turn forwards the browser control command message to the web browser plug-in 307. In step 1005, the web browser plug-in 307 executes the received browser control command in the Internet web browser 303. In step 1007, the web browser plug-in 307 sends a browser control complete message indicating the completion of the web browser control, to the internal connector 215 in Device A via the connection manager 313, and the internal connector 215. The internal connector 215 forwards the browser control complete message to the web browser controller 205. In step 1009, the web browser controller 205 outputs the browser control complete message on the output unit of the user interface 201 in Device A to notify the user of the completion of the browser control.

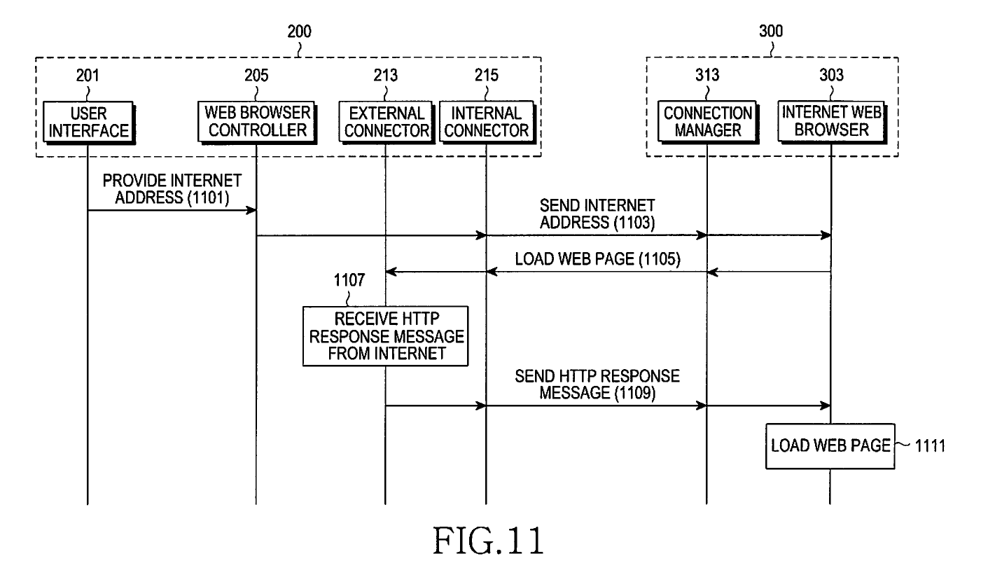

FIG. 11 illustrates a process of remotely controlling the Internet according to an embodiment of the present invention. Upon receiving an Internet address from the user, the user interface 201 in Device A provides the Internet address to the web browser controller 205, step 1101. In step 1103, the web browser controller 205 transmits the Internet address to the connection manager 313 in Device B via the internal connector 215, and the Internet address is entered in an address window of the Internet web browser 303. In step 1105, the Internet web browser 303 sends a Hypertext Transport Protocol (HTTP) request message with an HTTP request corresponding to the Internet address entered in the address window, to the internal connector 215 in Device A via the connection manager 313, and the internal connector 215 forwards the HTTP request message to the external connector 213.

In step 1107, the external connector 213 receives an HTTP response to the initial HTTP request via the Internet. In step 1109, the external connector 213 sends the HTTP response message to the connection manager 313 in Device B via the internal connector 215. The connection manager 313 forwards the HTTP response message to the Internet web browser 303. In step 1111, the web browser 303 loads the web page on the output unit of Device B using the HTTP response.

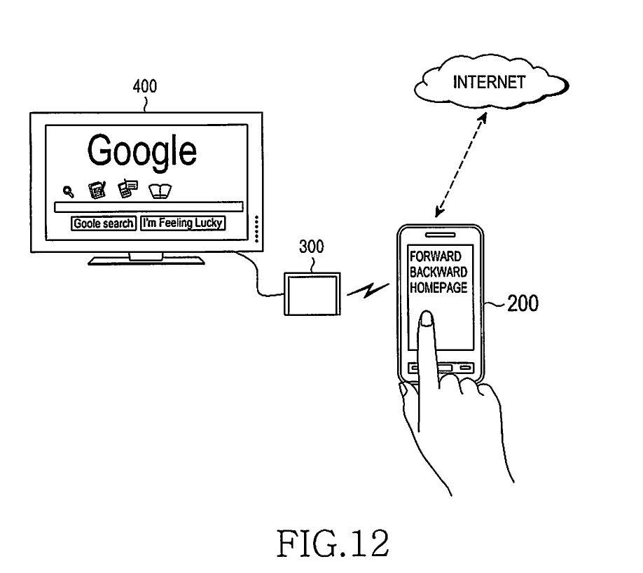

FIG. 12 illustrates Internet browsing according to an embodiment of the present invention. The Device A 200 and Device B 300 are connected to each other through a local communication network. Additionally, Device A 200 is connected to the Internet and the web browser running on Device B 300 operates under the control of Device A 200. The web browser may run on a separate output device, such as an LCD display or television 400.

While it has been described in FIG. 12 that Device B is separated from the output device 400, the device B may otherwise be embedded inside the output device 400.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A web browsing device, comprising:
a web browser equipped to connect to the Internet via a corresponding device that is connected to the web browsing device through a local communication protocol;
a display manager for rendering the browsing session; and
a control server for analyzing control commands and directing the web browser accordingly.

2. The device of claim 1, wherein the control server comprises:
a web browser plug-in for executing control commands on the web browser;
an input manager for managing input information received from the corresponding device, and generating an event based upon such input information; and
a connection manager for managing connections to the corresponding device using local communication.

3. The device of claim 2, wherein the input manager comprises:
a mouse input manager for analyzing mouse input information received from the corresponding device and generating an event corresponding to the mouse input information; and
a key input manager for analyzing key input information received from the corresponding device and generating an event corresponding to the key input information.

4. The device of claim 1, wherein the control commands are comprised of bookmark update information and browser control information.

5. The device of claim 1, wherein the web browsing device is mounted internally to an output device.

6. The device of claim 1, wherein the web browsing device is mounted externally to an output device.

7. The device of claim 1, wherein web browsing devices may be connected internally and externally to an output device.

8. A remote communication-enabled device, comprising:
a user interface for receiving commands and displaying control information; and
a control client for connecting to the Internet, connecting the Internet to a corresponding web browsing device through local communication, and transmitting commands and input data to the corresponding web browsing device.

9. The remote communication-enabled device of claim 8, wherein the control client comprises:
a web browser controller for controlling a web browser in the corresponding device using control commands received through the user interface;
an input manager for, upon receiving input data, transmitting the input data to the corresponding device; and
a connection manager for connecting with the corresponding device and connecting to the Internet to provide browsing capability to the corresponding device.

10. The remote communication-enabled device of claim 9, wherein the input manager comprises:
a mouse input manager for, upon receiving mouse input information, transmitting the mouse input information to the corresponding device; and
a key input manager for, upon receiving key input information, transmitting the key input information to the corresponding device.

11. The remote communication-enabled device of claim 9, wherein the connection manager comprises:
an external connector for connecting to the Internet using remote communication; and
an internal connector for connecting to the corresponding web browsing device, using local communication.

12. The remote communication-enabled device of claim 8, wherein the control commands comprise bookmark update information and browser control information.

13. A method for performing web browsing, comprising:
accessing the Internet with a remote communication-enabled device, and connecting the Internet to a web browsing device though local communication;
transmitting control commands and input information for controlling a web browser to the web browsing device; and
running a web browser using the received control commands on the web browsing device.

14. The method of claim 13, wherein the web browser is mounted in the web browsing device.

15. The method of claim 13, wherein the input information comprises mouse input information and key input information, and the web browsing device generates an input event using the input information.

16. The method of claim 13, wherein the control commands comprises bookmark update information and browser control information.

17. The method of claim 13, wherein the web browsing device is mounted inside an output device that renders web content.

18. The method of claim 13, where in the web browsing device is mounted outside an output device that renders web content.
